(19) United States
(12) Patent Application Publication
(10) Pub. No.: US 2026/0058718 A1
(43) Pub. Date: Feb. 26, 2026

(54) Temporally and Geographically Adaptive Satellite Constellation Network Management

(71) Applicant: CesiumAstro, Inc., Austin, TX (US)

(72) Inventors: Thomas Magesacher, Austin, TX (US); Danilo Dadic, Austin, TX (US); Mark Wiprud, Austin, TX (US); Scott Carnahan, Longmont, CO (US)

(73) Assignee: CesiumAstro, Inc., Austin, TX (US)

(21) Appl. No.: 17/474,890

(22) Filed: Sep. 14, 2021

(51) Int. Cl. H04B 7/185; H04W 92/06

(52) U.S. Cl. CPC H04B 7/18513; H04W 92/06

(57) ABSTRACT

A system may include a smart user (UE) device that includes one or more network interfaces and a processor coupled to the network interfaces. The network interfaces may include a first network interface configured to communicate with a satellite constellation and a second network interface configured to communicate with one or more gateways that are communicatively coupled to a core network. The processor may be configured to operate as a virtual gateway to forward data for other users between the core network and the satellite constellation. The smart UE device may allow a communication system to take advantage of available uplink and downlink bandwidth of one or more UE devices to distribute the data transmission load, thereby improving data throughput of the system.

### FIELD

The present disclosure is generally related to routing of data through a satellite network, and more particularly, to routing of data via an adaptive satellite constellation network management including temporally and geographically varying data paths.

### BACKGROUND

A satellite constellation consists of a set of satellites with communication equipment to connect to user devices (hereinafter referred to as UEs), gateways (GWs) on ground, and other satellites in the constellation (ISLs). The GWs may be communicatively coupled to a core network, which may include one or more networks, or which may communicate data to other networks.

The term UE may refer to a variety of different types of user devices including but not limited to movable devices that communicate data to and receive data from the satellite constellation, such as vehicles, vessels, aircraft, drones, and satellites that are not part of the constellation. Generally, UE devices may move geographically over time. The term UE may also refer to fixed terminals on private or business premises, which may communicate data to and receive data from the satellite constellation. In this classic state-of-the-art setup, GWs provide capacity for information flow towards (denoted FWD) and from (denoted RTN) user devices through the satellite constellation, and sometimes with the help of inter-satellite links.

### SUMMARY

Embodiments of systems, methods, and devices described herein reflect a paradigm change in terms of the routing of data to UE devices through the satellite network. Unlike conventional systems in which data routing is static (temporally and geographically) from the core network through static GWs to the satellite constellation and vice versa, embodiments of systems, methods, and devices described herein may provide adaptive data routing that may take advantage of available uplink bandwidth of UE devices to provide dynamic (temporally and geographically changing) data routing to and from the satellite constellation.

In some implementations, the UE device may be configured to operate as a virtual gateway to route data to the satellite constellation. Additionally, in some implementations, the UE device may be a data source, which may cache data, or which may generate data that can be routed to the satellite constellation. In still other implementations, one or more of the satellites may be configured to cache data, enabling routing of cached data from the satellite to the UE device or between satellites within the constellation.

In some implementations, a system may include a smart user (UE) device that includes one or more network interfaces and a processor coupled to the network interfaces. The network interfaces may include a first network interface configured to communicate with a satellite constellation and a second network interface configured to communicate with one or more gateways that are communicatively coupled to a core network. The processor may be configured to operate as a virtual gateway to forward data for other users between the core network and the satellite constellation. The smart UE device may allow a communication system to take advantage of available uplink and downlink bandwidth of one or more UE devices to distribute the data transmission load, thereby improving data throughput of the system.

In other implementations, a system may include a smart satellite within a satellite constellation. The smart satellite may include one or more communication interfaces and a processor coupled to the communication interfaces. The communication interfaces may include a first communication interface configured to communicate with one or more other satellites, a second communication interface configured to communicate with one or more gateways that are coupled to a core network, and a third communication interface configured to communicate with a smart user (UE) device and one or more other UE devices. The processor may be configured to determine one or more data paths for communication of data between the core network and a selected UE device. The one or more data paths may include an alternative data path that includes the smart UE device as the virtual gateway between the core network and the smart satellite.

In still other implementations, a system may include a smart user (UE) device and a smart satellite. The smart user (UE) device may include one or more network interfaces and a processor coupled to the network interfaces. The network interfaces may include a first network interface configured to communicate with a satellite constellation, a second network interface configured to communicate with one or more first gateways that are communicatively coupled to a core network, and a third network interface configured to communicate with a smartphone. The processor may be configured to operate as a virtual gateway to forward data for other users between the core network and the satellite constellation. The smart satellite may include one or more communication interfaces and a processor coupled to the communication interfaces. The communication interfaces may include a first communication interface configured to communicate with one or more other satellites inside or outside the satellite constellation, a second communication interface configured to communicate with one or more second gateways that are coupled to the core network, and a third communication interface configured to communicate with the smart UE device and one or more other UE devices. The processor may be configured to determine one or more data paths for communication of data between the core network and a selected UE device. The one or more data paths may include an alternative data path that includes the smart UE device as the virtual gateway between the core network and the smart satellite.

### BRIEF DESCRIPTION OF THE DRAWINGS

The detailed description is set forth with reference to the accompanying figures. In the figures, the left most digit(s) of a reference number identifies the figure in which the reference number first appears. The use of the same reference numbers in different figures indicates similar or identical items or features.

FIG. 1 depicts a block diagram of a system including a satellite constellation configured to route data to one or more UE devices.

FIG. 2 depicts a block diagram of a system including one or more smart UE devices that may operate as virtual gateways to provide dynamic routing to and from a satellite constellation, in accordance with certain embodiments of the present disclosure.

FIG. 3 depicts a block diagram of a system including a smart UE device, in accordance with certain embodiments of the present disclosure.

FIG. 4 depicts a block diagram of a system including a smart satellite configured to communicate with UE devices, in accordance with certain embodiments of the present disclosure.

FIG. 5 depicts a block diagram of a system including a smart UE device that may operate as a virtual gateway to send data originated by or cached by the smart UE device to the satellite constellation, in accordance with certain embodiments of the present disclosure.

FIG. 6 depicts a block diagram of a system including a smart UE device and a smart satellite, either or both of which may originate or generate data for transmission to other UE devices, in accordance with certain embodiments of the present disclosure.

FIG. 7 depicts a flow diagram of a method of dynamically routing data through multiple data paths including a smart UE device operating as a virtual gateway based on determined throughput data, in accordance with certain embodiments of the present disclosure.

While implementations are described in this disclosure by way of example, those skilled in the art will recognize that the implementations are not limited to the examples or figures described. The figures and detailed description thereto are not intended to limit implementations to the form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the work “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

Embodiments of systems, methods, and devices described herein may provide adaptive data routing that may take advantage of available uplink bandwidth of one or more smart user (UE) devices to provide dynamic (temporally and geographically changing) data routing to and from the satellite constellation. The term UE may refer to a variety of different types of user devices including but not limited to movable devices that communicate data to and receive data from the satellite constellation, such as vehicles, vessels, aircraft, drones, and satellites that are not part of the constellation. The term UE may also refer to fixed terminals on private or business premises, which may communicate data to and receive data from the satellite constellation.

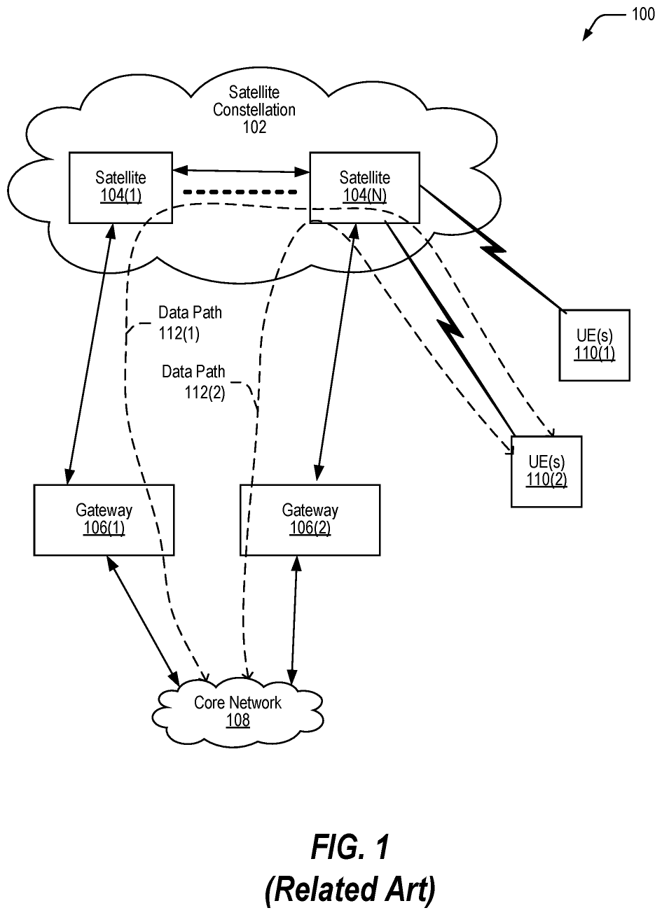

To understand the context of the present disclosure, it is helpful to have a baseline understanding of conventional satellite systems. An example of a conventional communication system including a satellite constellation is described below with respect to FIG. 1.

FIG. 1 depicts a block diagram of a system 100 including a satellite constellation 102 configured to route data to one or more UE devices 110. The satellite constellation may be comprised of a plurality of satellites 104, which may be distributed at various altitudes, and which may be configured to communicate with one another, with the UE devices 110, and with one or more gateways 106 on the ground.

The gateways 106 may include steerable ground-based antennas and transponders that receive signals from and transmit signals to satellites 104. The gateways 106 may also be coupled to a core network 108, which may include one or more networks. In some implementations, the core network 108 may include or may be communicatively coupled to local area networks (LANs), wide-area networks (WANs), proprietary networks, the Internet, or any combination thereof.

Conventionally, the gateways 106 may provide capacity for information flow from the core network 108 to the satellite constellation 102 and toward the UE devices 110, sometimes denoted as forward or FWD communications. The gateways 106 also enable information flow from the UE devices 110 through the satellite network 102 to the core network 108 through one or more of the gateways 106, sometimes denoted as return or RTN communications. In some instances, information may also be transmitted between satellites 104 within the satellite constellation 102 and between the satellite constellation 102 and other satellites that are outside of the satellite constellation 102.

In the illustrated example, the system 100 may communicate data along a first data path 112 that includes the core network 108, the gateway 106(1), the satellite 104(1), one or more other satellites including the satellite 104(N), and the UE device 110(2). The system 100 may also communicate data along a second data path 112(2) that includes the core network 108, the gateway 106(2), the satellite 104(N), and the UE device 110(2).

The gateways 106 are fixed ground stations. Consequently, the routing of data from the core network 108 to the UE devices 110 through the satellite constellation 102 relies on physical links/connections to provide the information flow. Classic UE devices 110 are often referred to as “terminals” since information flow terminates there: UEs are the source of transmitted information and the sink of received information but do not relay or forward information via alternative paths other than 112(1) or 112(2) to the core network. As more and more information delivery is based on delivery of entertainment content, the information uplink between the gateways 106 and the satellite constellation 102 may become a bottleneck, reducing uplink throughput, and adversely impacting the perceived connection at the UE device 110.

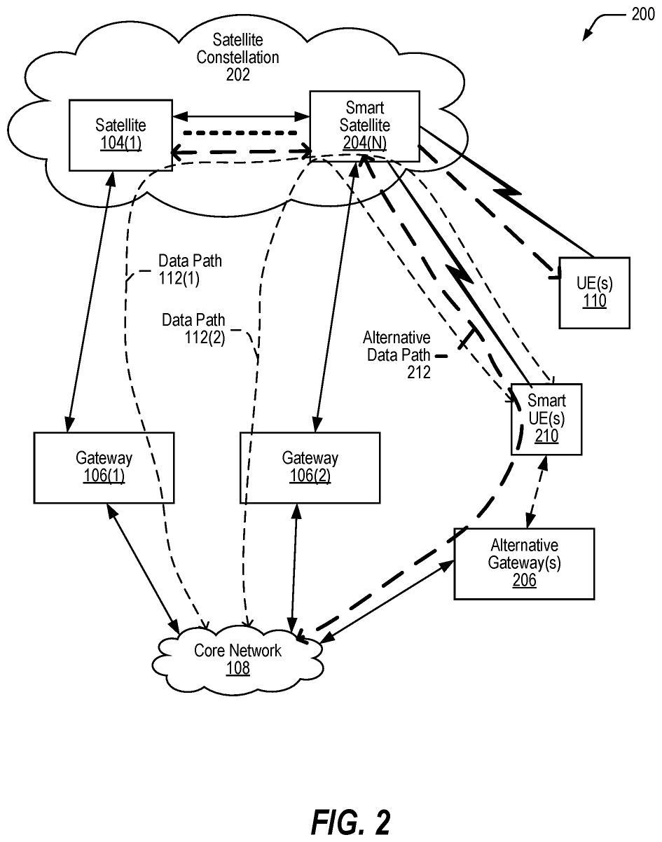

Embodiments of systems, methods, and devices are described below that include a smart satellite within the satellite constellation and one or more smart UE devices that are configured to communicate data to and receive data from the satellite constellation. In some implementations, the smart UE device may be configured to couple to the core network 108 via an alternative gateway. The smart satellite may be configured to utilize temporally and geographically variable smart UE devices to provide alternative data flow paths into and out of the satellite constellation, separating the physical links/connections from the information flow and providing adaptive, demand-based data flow routing. An example of a system including smart satellites and smart UE devices that enable dynamic data routing is described below with respect to FIG. 2.

FIG. 2 depicts a block diagram of a system 200 including one or more smart UE devices 210 that may operate as virtual gateways to provide dynamic routing to and from a satellite constellation 202, in accordance with certain embodiments of the present disclosure. In this example, the satellite constellation 202 may be the same as the satellite constellation 102 of FIG. 1, except that one or more of the satellites 104 may be replaced with smart satellites 204, which may enable information routing through alternative data paths 212 that may include a smart UE device 210.

In this example, a smart UE device 210 may operate as a gateway for others by virtue of having an alternative connection (Wi-Fi, 5G, cable, DSL, or other connection) to an alternative gateway 206, which may couple the smart UE device 210 to the core network 108. In an example, the smart UE device 210 may be associated with a vehicle, which may move into the range of a gateway that may communicatively couple with the smart UE device 210. This communication link may enable communication between the smart UE device 210 and the core network 108 independent of the satellite constellation 202 and may allow the smart UE device 210 to receive data from and send data to the core network 108. This communication link may be used to provide an alternative data path 212 for the smart satellite 204 to communicate data via the downlink path through the smart UE device 210 to the core network 108 and to receive data from the core network 108 via the uplink path through the smart UE device 210. The smart UE device 210 may forward information for others from the core network 108 to the smart satellite 204 or to other satellites 104 within the satellite constellation 202. In some implementations, the smart UE device 210 may operate as a source of information for others (caching information or storing alternative routing information) and may send the information to other smart UE devices 210 or to conventional UE devices 110 via one or more of the smart satellite 204 or other satellites 104 of the satellite constellation 202.

In the illustrated example, the system 200 may use vehicles (UE devices 210) that may change availability and geographic location temporally as the vehicle moves. The movable UE device 210 may bring a dynamically variable connection that can be used to provide an alternative data path 212 to send data to and to receive data from the satellite constellation 202. As the UE device 210 moves out of range from the alternative gateway 206, the UE device 210 may be removed from the data path 212 and a new data path may be selected from other UE devices 210 that have a connection through an alternative gateway 206 to the core network 108. Thus, the UE devices 210 may be used as virtual gateways in an ad hoc manner to deliver content to the satellite constellation 202 by utilizing available upload link bandwidth of UE devices 210 through alternative data paths 212.

In some implementations, the smart UE devices 210 may be configured to share return upload link bandwidth and forward data link bandwidth to send data for others. By providing alternative data paths 212 that utilize the smart UE devices 210, the latency of the system 100 may be reduced. In some implementations, a portion of the data may be routed through the alternative data paths 212, thereby reducing bottlenecks in the communications network in the forward uplink or return downlink paths in terms of data latency.

Depending on the implementation, the smart UE device 210 may be configured to facilitate data transfers to UE devices 110 or other smart UE devices 210 through the satellite constellation 202. In some implementations, the smart UE device 210 or the smart satellite 204 may be a data source and may send the data to a UE device 110 or to another satellite. Either or both of the smart UE device 210 or the smart satellite 204 may be configured to cache data that subsequently may be forwarded to other devices.

In some implementations, the smart UE device 210 may route incoming traffic from an alternative access link (an alternative gateway 206), which may include (but is not limited to) a 5G access link, a wireless local area network (WLAN) link, a fixed cable/fiber/DSL (digital service line) connection, an optical or a satellite link to a satellite that is not part of the satellite constellation 202 through the return (RTN) uplink (UL) satellite connection to satellites 104 or 204 of the satellite constellation 202, providing a secondary forward (FWD) UL.

In some implementations, the smart UE device 210 may become a source of information and a point of origin of content by virtue of storing the information in a local memory or by virtue of the processing capability of the smart UE device 210. The information may include, but is not limited to, cached information, such as software-update images to be broadcast to other UE devices 110 or 210 coupled to the satellite constellation 202. The information may also include data path routing information determined by the smart UE device 210 or even map information determined by a vehicle. The smart UE device may route the information through the RTN UL satellite link, and the smart satellite 204 may cache the information and selectively distribute the information to other satellites 104 or 204 in the satellite constellation 202. In some implementations, the smart satellite 210 may process the information before sending or without sending this information or parts of it via the RTN downlink (DL) back to the UE device 110, the smart UE device 210, or the gateway 106.

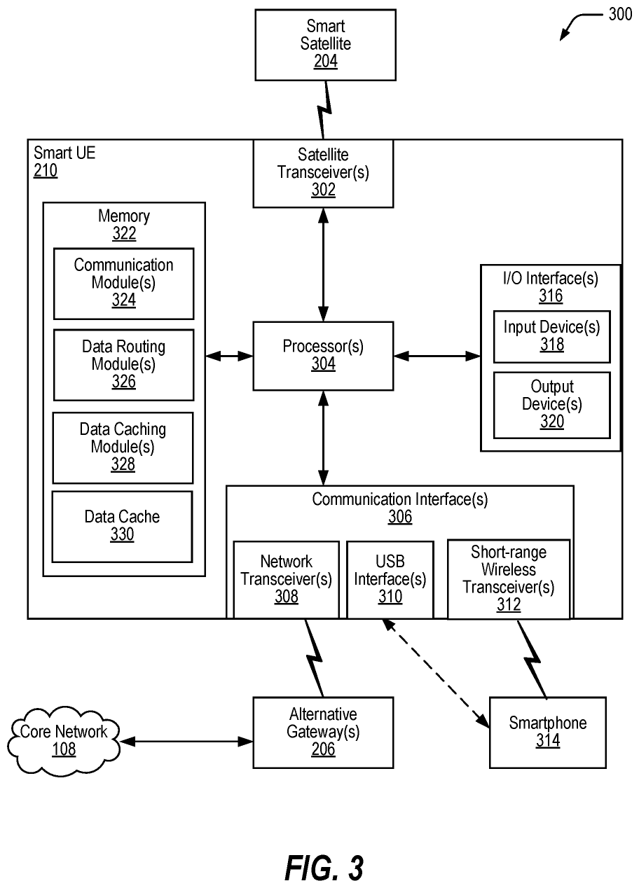

For a smart UE device 210 to function as a standard UE device 210 and to operate as a virtual gateway as needed, the smart UE device 210 may include instructions and optionally one or more network interfaces that may enable forwarding of data for others. One possible implementation of a smart UE device 210 is described below with respect to FIG. 3.

FIG. 3 depicts a block diagram of a system 300 including a smart UE device 210, in accordance with certain embodiments of the present disclosure. The smart UE device 210 may be configured to communicate with a smart satellite 204 within the satellite constellation 202. The smart UE device 210 may be configured to communicatively couple to the alternative gateway 206 to communicate with the core network 108. The smart UE device 210 may also be configured to communicate with a smartphone 314 or other computing device.

The smart UE device 210 may include one or more satellite transceivers 302, which may be configured to send data to and to receive data from the smart satellite 204. The smart UE device 210 may include one or more processors 304, which may be coupled to the satellite transceivers 302 and configured to execute processor-readable instructions. The smart UE device 210 may also include one or more communication interfaces 306 coupled to the one or more processors 304. The communication interfaces 306 may include one or more network transceivers 308, which may be configured to communicatively couple to the alternative gateway 306 to send and receive data from the core network 108. The communication interfaces 306 may also include one or more universal serial bus (USB) interfaces 310, which may include one or more connection ports that may be configured to couple to a smartphone 314 or other computing device. The one or more network interfaces 306 may include one or more short-range wireless transceivers 312, which may be configured to communicate with the smartphone 314 or other computing device through a wireless communications link. The short-range wireless transceivers 312 may include a Bluetooth transceiver or other transceivers.

The smart UE device 210 may include one or more I/O interfaces 316 coupled to the one or more processors 304. The I/O interfaces 316 may include input devices 318 and output devices 320. The input devices 318 may include buttons, knobs, a touchscreen, other input devices, or any combination thereof. The output devices 320 may include the touchscreen, a speaker, other output devices, or any combination thereof.

The smart UE device 210 may include a memory 322 coupled to the one or more processors 304. The memory 322 may include one or more communication modules 324 that may cause the processor 304 to receive data from one of the network transceiver 308 or the satellite transceiver 302 and to forward the data to one of the satellite transceiver 302 or the network transceiver 308.

The memory 322 may include one or more data routing modules 326 that may cause the processor 304 to determine a data route to the satellite constellation 202 or to the core network 108. The data routing modules 326 may cause the processor 304 to determine data paths 212 or routes across selected physical links. In some implementations, rather than pick a best available connection, the data routing modules 326 may identify multiple data paths 212 and may cause the processor 408 to route portions of the data through each of the various data paths 212. The memory 322 may include one or more data caching modules 328 that may cause the processor 304 to selectively store data in a data cache 330 or to retrieve data from the data cache 330.

In some implementations, the communication modules 324 may cause the processor 304 to communicate with a smart satellite 204 to provide data including available uplink bandwidth data. The smart satellite 204 may be configured to make use of the available uplink bandwidth data to determine whether to use an alternative data path 212 that includes the smart UE device 210. The communication modules 324 may also receive instructions from the smart satellite 204 (or from the core network 108) to forward data for others. The smart UE device 210 may use the data routing modules 326 to determine one or more data paths 212 to route the data for others to one or more of the core network 108 via the alternative gateway 206 or the smart satellite 204.

The data caching module 328 may cause the processor 304 to store data in a data cache 330. In some implementations, the smart UE device 210 may act as a data source and may send data from the data cache 330 to the smart satellite 204 for distribution. Such cache information may include broadcast-like content for streaming applications, software-update images, other data, or any combination thereof. In an example, the cached data may include software-update image data as it appears in the user's field of view for further distribution or caching.

In some implementations, the smart UE device 210 may generate new information (such as route information) by virtue of its processing capability. Accordingly, the smart UE device 210 may become an origin of information that is independent from the core network 106. In some implementations, the data routing module 326 may cause the processor to determine data routing information.

Alternatively, the smart UE device 210 may store information in a data cache 330, which may be an unused portion of the non-volatile memory of the UE device 210 that may be used to store information from other UE devices 110, from the core network 108, or from another source. In this instance, the smart UE device 210 may be a data source that may send the information to the core network 106 or to the smart satellite 204 in response to a request.

The smart UE device 210 may be communicatively connected to the core network 106 and to the satellite constellation 202 through several different physical links (such as one or more of the data paths 112 or 212. These links may be active simultaneously or used one-by-one over time. The UE device 210 may also maintain a private link or connection, such as a virtual private network (VPN) protected link.

In some implementations, the smart UE device 210 may forward the information to the satellite constellation 202 or to the core network 108 at the IP layer or the transport layer, without interrupting user-level processes. The forwarding operations may occur in the background and may take advantage of unused, available bandwidth within the FWD UL or the RTN DL of the smart UE device 210.

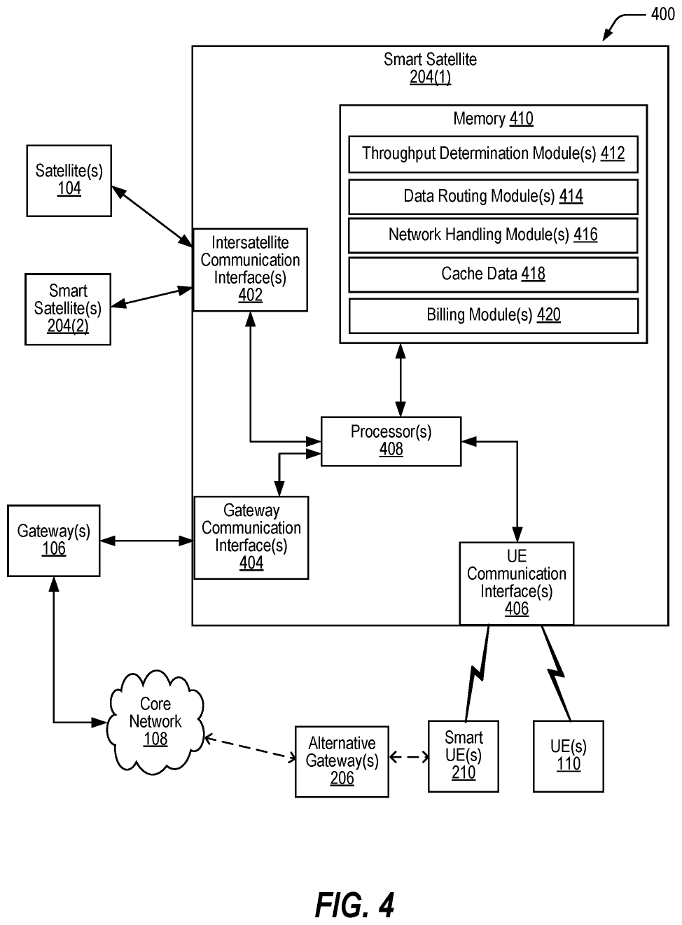

In some implementations, the smart satellite 204 within the satellite constellation 202 may be configured to route data through the smart UE device 210 or to receive data that was routed through the smart UE device 210. In some implementations, the smart satellite 204 may originate routing data or may operate as a content source. An example of a smart satellite 204 is described below with respect to FIG. 4.

FIG. 4 depicts a block diagram of a system 400 including a smart satellite 204 configured to communicate with UE devices 110 (and smart UE devices 210), in accordance with certain embodiments of the present disclosure. The smart satellite 204(1) may be configured to communicate with one or more of a satellite 104 or a smart satellite 204(2) within or outside of the satellite constellation 202. The smart satellite 204 may also communicate with one or more gateways 106 and with the core network 108 through the one or more gateways 106. The smart satellite 204 may communicate with one or more UE devices 110, with one or more smart UE devices 210, and with the core network 106 through one or more smart UE device 210 and corresponding one or more alternative gateways 206.

The smart satellite 204 may include one or more intersatellite communication interfaces 402, which may be configured to send data to and to receive data from one or more satellites 104 or one or more other smart satellites 204(2). The smart satellite 204 may include one or more gateway communication interfaces 404, which may be configured to communicate wirelessly with ground-based systems, such as the one or more gateways 106. The smart satellite 204 may include one or more UE communication interfaces 406, which may communicate data to UE devices, such as the UE devices 110, smart UE devices 210, or any combination thereof. The interfaces 402, 404, and 406 may include antennas, beam-forming circuitry, and other circuitry and firmware to enable wireless communications by the smart satellite 204. In some implementations, the interfaces 402, 404, and 406 may be combined in a single integrated communication structure.

The smart satellite 204 may include one or more processors 408 coupled to the interfaces 402, 404, and 406. The one or more processor 408 may be coupled to a memory 410, which may store processor-readable instructions and data. The memory may include a throughput determination module 412 that, when executed, may cause the processor to determine one or more metrics associated with the download and upload link of each communication link. The one or more metrics may include the throughput and may include information received from one or more of the smart UE devices 210. The throughput determination module 412 may be configured to determine inter-beam and intra-beam user-side routing capabilities based on the one or more metrics. Additionally, the throughput determination module 412 may be configured to determine dynamic network state information, such as identifiers and locations of UE devices 210 with source capacity.

The memory 410 may include one or more data routing modules 414 that, when executed, may cause the processor 408 to determine one or more alternative routes 212 to or from the core network 106. The data routing modules 414 may identify one or more smart UE devices 210 through which the smart satellite 204 may send data to or receive data from the core network 106. In some implementations, the data routing module 414 may cause the processor 408 to determine a smart UE device that has cached data that may be sent to another UE device 110 or 210 and may determine one or more data paths 212 to send provide the cached data via a selected data path 212. The alternative data paths 212 may enable transfer of data via inter-satellite or intra-satellite links, gateways 106 or 206, or smart UE devices 210.

The memory 410 may include one or more network handling modules 416 that, when executed, may cause the processor 408 to determine one or more selected data paths based on the data paths determined by the data routing modules 414. In some implementations, the network handling modules 416 may be distributed across multiple smart satellites 204. The network handling modules 416 may cause the processor to identify useful portions of a data stream to be cached. For example, if a UE device 110 or 210 has an ongoing download or stream being serviced by a leading satellite (e.g., another smart satellite 204 or another satellite 104) and if the uplink capacity in the leading satellite is scarce but available in the smart satellite 204, the smart satellite 204 may pre-cache a useful portion of the data stream to facilitate the transfer. The precached data may be stored in the memory 410 as cache data 418, which may include data received from one or more data sources. The smart satellite 204 may store the cached data 416 in the memory 410 for subsequent transmission to the leading satellite or a UE device 110 or a smart UE device 210. The cache data 418 may also include data generated by the processor 408 of the smart satellite 204, such as alternative path data from the data routing modules 414, available uplink or downlink paths for dynamic path selection, other data, or any combination thereof.

In some implementations, the memory 410 may also include a billing module 420, which may track data forwarding by the smart UE devices 210 to compensate for or to track and properly allocate the usage for billing purposes. A smart UE device 210 that allows for forwarding of data on behalf of other users should not penalize the data limits of the smart UE device 210, so the usage data needs to be tracked so that the data usage can be allocated appropriately. The billing module 420 may facilitate such tracking.

In some implementations, the billing module 420 may determine the cost of a particular data path 212. The cost may be based on roaming charges, network availability, and the like. If the cost exceeds a threshold value, the billing module 420 may alert the network handling modules 416 so that the expensive data path 212 is not selected.

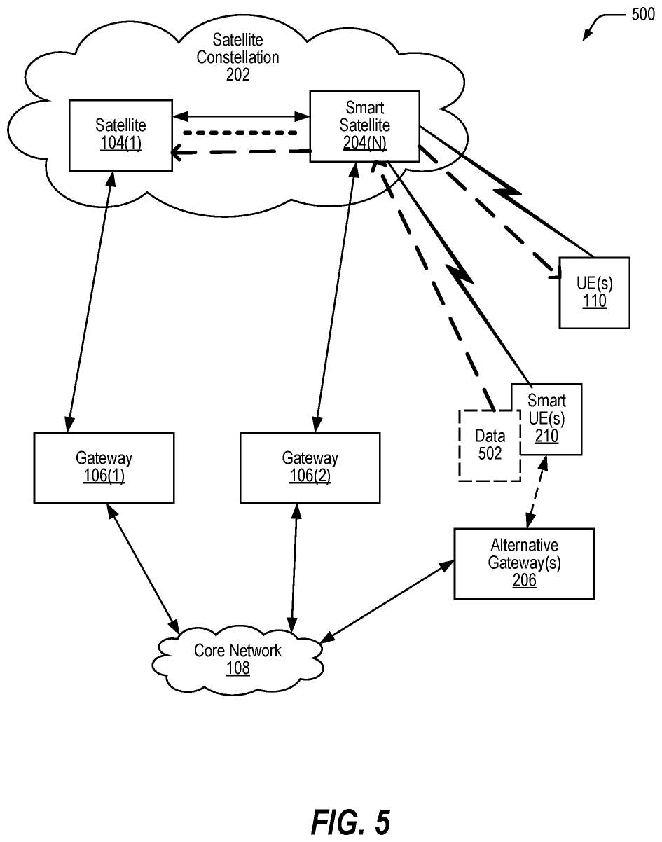

FIG. 5 depicts a block diagram of a system 500 including a smart UE device 210 that may operate as a virtual gateway to send data originated by or cached by the smart UE device 210 to the satellite constellation 202, in accordance with certain embodiments of the present disclosure. In this illustrated example, the smart UE device 210 may include a data cache 330, which may store data 502. The smart UE device 210 may operate as a data source, providing data 502 to the satellite constellation 202 via the smart satellite 204. The smart satellite 204 may send the data 502 to other satellites 104, other smart satellites 204, other smart UE devices 210, or other UE devices 110.

In some implementations, the data 502 may be originated by the smart UE device 210. In other implementations, the data 502 may be received from the core network 108 or from other UE devices 110 or 210 and may be stored at the smart UE 210 for later transmission. The data 502 may include images, text, or other data. In some implementations, the data 502 may include alternative route data defining one or more alternative data paths 212. The data 502 may alternatively be stored in a user device, such as a smartphone coupled to the smart UE device 210. The data 502 may be received by the smart UE device 210 via the alternative data path 212 or from the satellite constellation 202 and may be stored in the data cache 330 to use at appropriate times and locations (such as to upload a software-update image to a satellite 104 or a smart satellite 204 for further distribution as the satellite 104 or the smart satellite 204 appears in the field of view of the smart UE device 210). Other implementations are also possible.

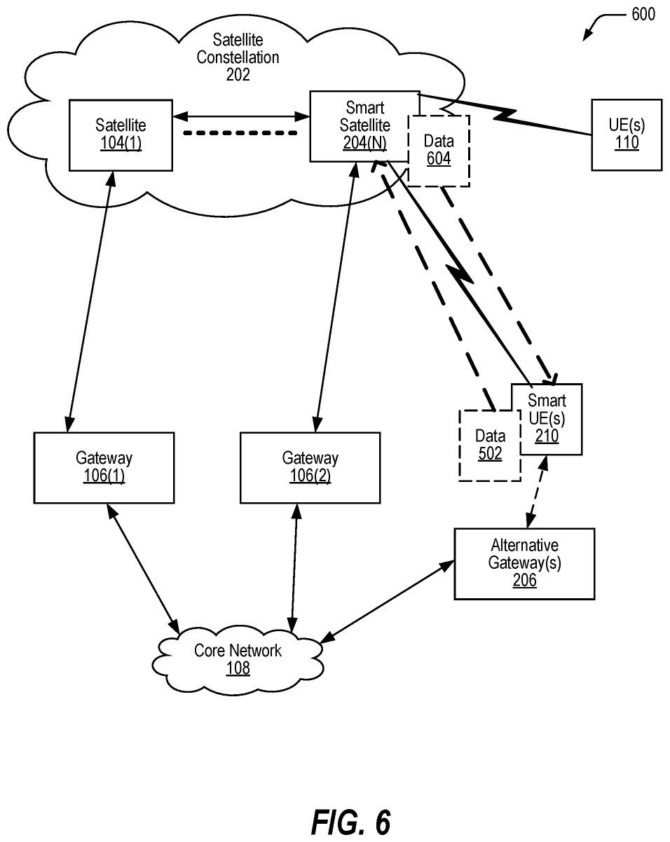

As previously mentioned, the smart satellite 204 may also originate or store data for subsequent transmission. An illustrative example of a system in which the smart satellite 204 stores and optionally sends stored data is described below with respect to FIG. 6.

FIG. 6 depicts a block diagram of a system 600 including a smart UE device 210 and a smart satellite 204, either or both of which may be the origin of data for transmission to other UE devices 110 or 210, in accordance with certain embodiments of the present disclosure. In this example, the smart satellite 204 may include stored user data, stored content, stored data paths, other data, or any combination thereof in the data cache 418 and may send the data 604 to other satellites 104 or 204, UE devices 110, smart UE devices 210, the core network 108, or any combination thereof. The data 604 may reach the smart satellite 204 via a gateway 106, a gateway 106 plus an inter-satellite link from another satellite 104 or 204, or an alternative data path 212 that may include a smart UE device 210. The received information may be stored in the data cache 418 for use at appropriate times and locations (such as broadcast-like contents for streaming applications, software-update images, and so on).

In some implementations, the smart satellite 204 may selectively store received data based on content requests. For example, if the received data has been requested multiple times by different UE devices, the smart satellite 204 may store received data in the data cache 418 to service the requests without having to retrieve the data from the original source. Subsequent requests may be serviced by retrieving the data 604 from the data cache 418 and sending the data 604 via a selected data path to a destination device, such as the smart UE device 210 or the UE device 110.

Alternatively, the smart satellite 204 may generate the data 604 and store the generated data 604 in the data cache 418. Such generated data 604 may include alternative data paths 212, upload metrics, download metrics, other data, or any combination thereof. As needed, the smart satellite 210 may retrieve and use or forward the data 604.

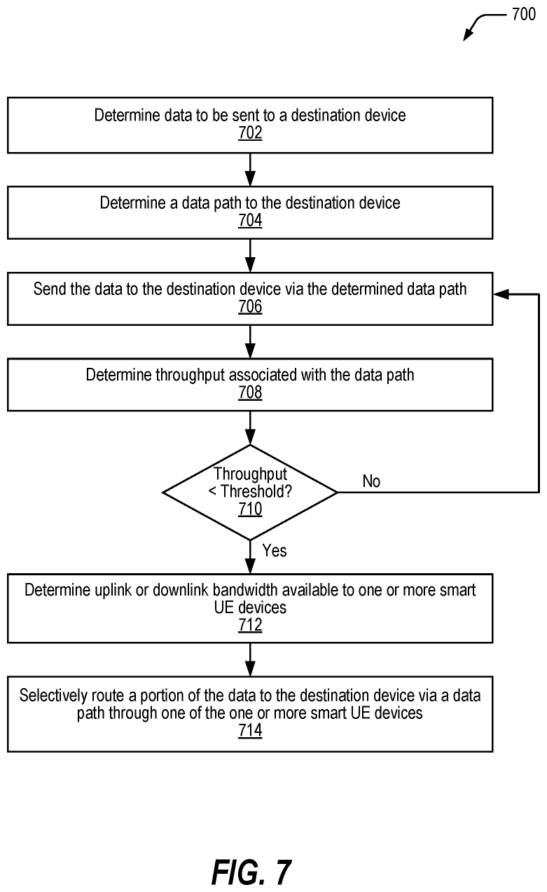

FIG. 7 depicts a flow diagram of a method 700 of dynamically routing data through multiple data paths including a smart UE device 210 operating as a virtual gateway based on determined throughput data, in accordance with certain embodiments of the present disclosure. At 702, the method 700 may include determining data to be sent to a destination device. The data may include content for presentation at a UE device 110 or a smart UE device 210.

At 704, the method 700 may include determining a data path to the destination device. The data path may include one or more inter-satellite links, one or more gateways, and one or more links to a UE device 110 or a smart UE device 210.

At 706, the method 700 may include sending the data to the destination device via the determined data path. The data may be streamed from the smart satellite 204 to a UE device 110 or to the smart UE device 210.

At 708, the method 700 may include determining throughput associated with the data path. In some implementations, the transmitting device (e.g., smart satellite 204, smart UE device 210, or even a data source within the core network 108) may determine one or more metrics associated with the transmission. The metrics may include error rates, throughput, other data, or any combination thereof.

At 710, the method 700 may determine whether the throughput is less than a threshold. If, at 710, the throughput is greater than or equal to a threshold, the method 700 may include returning to 706 to continue sending the data to the destination device via the determined path. Otherwise, at 710, if the throughput is less than the threshold, the method 700 may include determining uplink or downlink bandwidth available to one or more smart UE devices 210. In some implementations, the availability may be determined by querying the one or more smart UE devices 210 or by receiving data indicative of the availability from one or more of the smart UE devices 210, at 712.

At 714, the method 700 may include selectively routing a portion of the data to the destination device via a data path through one or more of the smart UE devices 210. In this example, the data path may be an alternative data path 212, which may use the smart UE device 210 as a virtual gateway to send data from the core network 108 that is destined for other devices to the satellite constellation 202 for forwarding or further distribution.

In conjunction with the systems, methods, and devices described herein, a smart UE device 210 may be configured to operate as a virtual gateway by establishing a connection to the core network 108 through one or more alternative gateways and by establishing a connection to the satellite constellation 202 to provide an alternative data path 212. The smart UE device 210 may forward information to the satellite constellation 202 or to forward information from the satellite constellation 202 to the core network 108, improving overall throughput.

In some implementations, the smart UE device 210 may be a data source for other UE devices 110, other smart devices 210, or smart satellites 204. In such an example, the smart UE device 210 may originate data, such routing data (alternative data paths 212), and may store the originated data in a local memory until it is needed, at which time the smart UE device 210 may forward the data to the smart satellite 204. In some instances, the smart UE device 210 may store data from the core network 108 or from other UE devices 110 for subsequent use. When the stored data is requested, the smart UE device 210 may forward the data from its local memory to the satellite constellation 202. Other implementations are also possible.

In some implementations, the system may include a smart satellite 204 that may be configured to store information and to forward stored information to UE devices 110, to smart UE devices 210, to other smart satellites 204, to other satellites 104 that are within or outside of the satellite constellation 202, or any combination thereof. The smart satellite 204 may be configured to determine data transmission parameters (such as uplink throughput, downlink throughput, other parameters, or any combination thereof) and may selectively determine one or more data paths to receive information and to provide the information to a UE device 110 or a smart UE device 210. The one or more data paths may include an alternative data path 212 that uses one or more smart UE devices 210 as a virtual gateway for transmission of data from the core network 106 to the satellite constellation 202, from the local memory of the smart UE device 210 to the satellite constellation 202, or from one or more of the satellites 104 or smart satellites 204 to the core network 108.

In some implementations, the smart satellite 204 may store information locally, which may include content received from a UE device 110, from a smart UE device 210, from another satellite 104 or 210, or from the core network 108. As needed, the smart satellite 204 may retrieve the stored data from its local memory and may forward the data to one or more of a UE device 110, a smart UE device 210, a satellite 104 (within or outside of the satellite constellation 202), another smart satellite 204, or any combination thereof.

The systems, methods, and devices described herein may enable improved data transmission by taking advantage of available uplink or downlink bandwidth of one or more smart UE devices 210 to send at least a portion of the data. Further, the systems, methods, and devices described herein may reduce the data load on the core network 108 and the gateways 106 by storing some of the data locally at the smart UE devices 210 or at the smart satellites 204, enabling transmission directly from the smart UE device 210 or the smart satellite 204 and bypassing the conventional data transmission paths 112. Additionally, in some implementations, the smart satellite 204 may send a portion of the data to the core network 108 through a conventional data path 110 that includes one or more satellites 104 or 210 and one or more gateways 106. Additionally, to enhance throughput, the smart satellite 204 may send a selected portion of the data to the core network 108 through an alternative data path 212 that includes a smart UE device 210 and an alternative gateway 206.

Although the present invention has been described with reference to preferred embodiments, workers skilled in the art will recognize that changes may be made in form and detail without departing from the scope of the invention.

What is claimed is:

1. A system comprising:
a smart user (UE) device comprising:
one or more network interfaces including a first network interface configured to communicate with a satellite constellation and a second network interface configured to communicate with one or more alternative gateways that are communicatively coupled to a core network; and
a processor coupled to the one or more network interfaces and configured to operate as a virtual gateway to forward data for other users between the core network and the satellite constellation.

2. The system of claim 1, wherein the one or more network interfaces includes a third network interface configured to communicate with a smartphone.

3. The system of claim 1, further comprising:
a memory coupled to the processor and configured to store cache data; and
wherein the processor is configured to send the cache data to the satellite constellation.

4. The system of claim 3, wherein the cache data comprises one or more of data received from the core network or data received from the satellite constellation.

5. The system of claim 3, wherein the cache data comprises alternative data path data determined by the processor.

6. The system of claim 1, further comprising:
a smart satellite within the satellite constellation, the smart satellite comprising:
one or more communication interfaces including a first communication interface configured to communicate with one or more gateways that are coupled to the core network, a second communication interface configured to communicate with the smart UE device and one or more other UE devices; and
a processor coupled to the one or more communication interfaces, the processor configured to determine one or more data paths for communication of data between the core network and a selected UE device, the one or more data paths including an alternative data path that includes the smart UE device as the virtual gateway between the core network and the smart satellite via the alternative gateway.

7. The system of claim 6, wherein the one or more communication interfaces comprise a third communication interface configured to communicate with one or more other satellites.

8. The system of claim 6, wherein the smart satellite further comprises:
a memory coupled to the processor and configured to store data determined by the processor or received from one or more of the UE device, the smart UE device, or another satellite; and
wherein the processor may retrieve the stored data from the memory and forward the stored data to another satellite or to the selected UE device.

9. The system of claim 6, wherein the processor of the smart satellite is configured to determine available bandwidth associated with a smart UE device and to determine the alternative data path to the core network through the smart UE device based on the available bandwidth.

10. A system comprising:
a smart satellite within a satellite constellation, the smart satellite comprising:
one or more communication interfaces including a first communication interface configured to communicate with one or more gateways that are coupled to a core network, a second communication interface configured to communicate with a smart user (UE) device and one or more other UE devices; and
a processor coupled to the one or more communication interfaces, the processor configured to determine one or more data paths for communication of data between the core network and a selected UE device, the one or more data paths including an alternative data path that includes the smart UE device as the virtual gateway between the core network and the smart satellite via the alternative gateway.

11. The system of claim 10, wherein the one or more communication interfaces comprise a third communication interface configured to communicate with one or more other satellites.

12. The system of claim 10, wherein the smart satellite further comprises:
a memory coupled to the processor and configured to store data determined by the processor or received from one or more of the UE device, the smart UE device, or another satellite; and
wherein the processor may retrieve the stored data from the memory and forward the stored data to another satellite or to the selected UE device.

13. The system of claim 10, wherein the processor of the smart satellite is configured to determine available bandwidth associated with the smart UE device and to determine the alternative data path to the core network through the smart UE device based on the available bandwidth.

14. The system of claim 10, further comprising:
a smart user (UE) device comprising:
one or more network interfaces including a first network interface configured to communicate with the satellite constellation and a second network interface configured to communicate with an alternative gateway that is communicatively coupled to the core network; and
a processor coupled to the one or more network interfaces and configured to operate as a virtual gateway to forward data for other users between the core network and the satellite constellation.

15. The system of claim 14, wherein the one or more network interfaces includes a third network interface configured to communicate with a smartphone.

16. The system of claim 14, further comprising:
a memory coupled to the processor and configured to store cache data; and
wherein the processor is configured to send the cache data to the satellite constellation; and
wherein the cache data comprises one or more of data received from the core network, data received from the satellite constellation, or alternative data path data determined by the processor of the smart UE device.

17. A system comprising a smart user (UE) device and a smart satellite:
the smart user (UE) device comprising:
one or more network interfaces including a first network interface configured to communicate with a satellite constellation, a second network interface configured to communicate with one or more first gateways that are communicatively coupled to a core network, and a third network interface configured to communicate with a smartphone; and
a processor coupled to the one or more network interfaces and configured to operate as a virtual gateway to forward data for other users between the core network and the satellite constellation;
the smart satellite within the satellite constellation, the smart satellite comprising:
one or more communication interfaces including a first communication interface configured to communicate with one or more other satellites inside or outside the satellite constellation, a second communication interface configured to communicate with one or more second gateways that are coupled to the core network, and a third communication interface configured to communicate with the smart UE device and one or more other UE devices; and
a processor coupled to the one or more communication interfaces, the processor configured to determine one or more data paths for communication of data between the core network and a selected UE device, the one or more data paths including an alternative data path that includes the smart UE device as the virtual gateway between the core network and the smart satellite.

18. The system of claim 17, wherein the smart satellite further comprises:
a memory coupled to the processor and configured to store data determined by the processor or received from one or more of the UE device, the smart UE device, or another satellite; and
wherein the processor may retrieve the stored data from the memory and forward the stored data to another satellite or to the selected UE device.

19. The system of claim 17, wherein the processor of the smart satellite is configured to determine available bandwidth associated with the smart UE device and to determine the alternative data path to the core network through the smart UE device based on the available bandwidth.

20. The system of claim 17, wherein the smart UE device further comprises:
a memory coupled to the processor and configured to store cache data; and
wherein:
the cache data includes one or more of data received from the core network, data received from one or more satellites of the satellite constellation, or data determined by the processor of the smart UE device; and
the processor of the smart UE device is configured to send the cache data to the satellite constellation; and
wherein the cache data comprises alternative data path that includes the smart UE device.
